(19) United States
(12) Patent Application Publication
(10) Pub. No.: US 2016/0194195 A1
(43) Pub. Date: Jul. 7, 2016

(54) A SYSTEM AND METHOD FOR TRACKING DISPENSATION OF FUEL FROM A PLURALITY OF FUEL STATIONS

(71) Applicant: RELIANCE INDUSTRIES LIMITED, Mumbai, Maharashtra (IN)

(72) Inventors: Atul Ravindra KABRE, Navi-Mumbai (IN); Ketan Chhotalal MANWAR, Vadodara (IN)

(21) Appl. No.: 14/916,629

(22) PCT Filed: Sep. 8, 2014
(86) PCT No.: PCT/IN2014/000586

§ 371 Date: Mar. 4, 2016

(30) Foreign Application Priority Data
Sep. 6, 2013 (IN) 2897/MUM/2013

(51) Int. Cl. B67D 7/22; G06Q 20/18; B67D 7/04

(52) U.S. Cl. CPC B67D 7/228; B67D 7/04; G06Q 20/18

(57) ABSTRACT

A system and method for tracking dispensation of fuel from a plurality of fuel stations comprising, a plurality of dispenser slave modules, a plurality of gauges, a plurality of gauge slave modules, a plurality of price display slave modules, a plurality of access points, a plurality of controllers, wherein each controller comprises a first master module and a second master module and a server comprising a transceiver and an analytical engine.

### FIELD OF THE DISCLOSURE

The present disclosure relates to a tracking system for fuel dispensers.

### DEFINITIONS

The expression ‘tracking’ used hereinafter in the specification refers to but is not limited to monitoring one or more states or parameters such as delivery, price, quantum, purchase transactions, working hours of a dispensing system and such related processes/transactions/business needs associated with the same.

The expression ‘Power-Line Communication’ used hereinafter in the specification refers to a method for communicating data over power lines. A typical power line communicator includes a master module and a slave module. The master module and the slave module communicate data between each other via a connected power line.

The expression ‘Dispenser slave module’ used hereinafter in the specification refers to a slave module of a power line communicator attached to the electronics of a fuel dispenser. It senses and transmits data hereafter referred to as ‘dispenser data’.

The expression ‘Gauge’ used hereinafter in the specification refers to a measuring device. In accordance to the present disclosure a gauge is used to measure the quantity of fuel in a fuel sump.

The expression ‘Gauge slave module’ used hereinafter in the specification refers to a slave module of a power line communicator attached to the gauge. It senses and transmits data hereafter referred to as the ‘gauge data’.

The expression ‘Price system slave module’ used hereinafter in the specification refers to a slave module of a power line communicator attached to the price display module. In accordance to the present disclosure it receives data hereafter referred to as the ‘price system data’.

The expression ‘current total’ used hereinafter in the specification refers to a current total price of the fuel dispensed.

These definitions are in addition to those expressed in the art.

### BACKGROUND

Automated dispensing systems for candy, soft drinks, fizzy drinks, soap, fuel and the like provide commodities at locations convenient to the consumers and to meet the demand for the commodity. For instance, the genesis of automation systems for fuel dispensing lies in the state of the current fuel scenario and its effect on world economy. One of the key functions of an automation system for a fuel station is to capture transaction information from fuel dispensers at the fuel forecourt. Retail automation systems are designed to capture, monitor and control fuel transactions at the forecourt. Automation systems are typically installed in sales buildings. Forecourt devices like dispensers, tank gauges, price lines and payment terminals are connected using special communication cables laid in underground conduits. Laying of underground conduits from dispensers is a time consuming and expensive affair especially in operating stations since dispensers are installed in the center of the forecourt. This may result in loss of sales until the underground work is completed or may hamper operations till full restoration. Due to this constraint, automating existing operational fuel stations without disturbing its operation is difficult, time consuming and an expensive affair.

Capturing sales and inventory information to carry out daily reconciliation of fuel or any such commodity being dispensed, is an urgent need faced by every retail station. Additionally, automation of functional dispensing stations in a cost effective, reliable, easy to implement means without the need for cumbersome civil procedures is the need of the hour.

### OBJECTS

Some of the objects of the present disclosure aimed to ameliorate one or more problems of the prior art or to at least provide a useful alternative are described herein below:

An object of the disclosure is to provide a cost effective dispenser tracking system.

Another object of the disclosure is to provide a system and method for tracking dispensation of fuel from a plurality of fuel stations that can be interfaced with operating dispensing stations.

Yet another object of the disclosure is to provide a system and method for tracking dispensation of fuel from a plurality of fuel stations that can be implemented without a need for major civil work.

Still another object of the disclosure is to provide a system and method for tracking dispensation of fuel from a plurality of fuel stations that is easy to install and does not involve cumbersome time consuming installation procedures.

An additional object of the disclosure is to provide a system and method for tracking dispensation of fuel from a plurality of fuel stations that can be easily implemented for enterprise level control.

Yet another object of the disclosure is to provide a reliable dispenser tracking system.

One more object of the disclosure is to provide a system and method for tracking dispensation of fuel from a plurality of fuel stations that can improve sales without a need for additional overheads.

Still one more object of the disclosure is to provide a system and method for tracking dispensation of fuel from a plurality of fuel stations that does not require on-site maintenance, diagnostics or component replacement.

Another object of the present disclosure is to provide a system and method for tracking dispensation of fuel from a plurality of fuel stations that identifies irregularities and discrepancies at the fuel stations.

Yet another object of the present disclosure is to provide a system and method for tracking dispensing of fuel from a plurality of fuel stations that can be used for remote monitoring of the fuel stations.

A further object of the present disclosure is to provide a system and method for tracking dispensation of fuel from a plurality of fuel stations which reduces hardware requirements in comparison to conventional systems.

Other objects and advantages of the present disclosure will be more apparent from the following description when read in conjunction with the accompanying figures, which are not intended to limit the scope of the present disclosure.

### SUMMARY

In accordance to a present disclosure there is provided a system for tracking dispensation of fuel from a plurality of fuel stations, each fuel station having a cluster of fuel dispensers and each fuel dispenser being associated with a fuel sump, a metering device, a fuel dispensing nozzle, a price display module and at least one handheld device, wherein each handheld device is in wireless communication with the metering device of at least one dispenser, the system including a plurality of dispenser slave modules, each attached to one of the dispensers, a plurality of gauges each mounted in one of the fuel sumps, a plurality of gauge slave modules each attached to one of the gauges, a plurality of price display slave modules each attached to the price display module at each of the fuel stations, a plurality of access points each located in one of the fuel stations and in wireless communication with the handheld device, a plurality of controllers, wherein a controller is located in each of the fuel stations, each the controller including a first master module communicating via power lines the dispenser slave module, the gauge slave module and the price display slave module to receive dispenser nozzle data, dispenser meter data and gauge data from the dispenser slave module and gauge slave module and deliver pricing data to the dispenser meter slave module and the price display slave module and a second master module in data communication with the first master module and in cable communication with the access point at the fuel station to receive and send handheld device data via and to the access point and a server including a transceiver to receive from a plurality of the controllers the dispenser data, the gauge data and the handheld device data and deliver the pricing data to each of the controllers and an analytical engine to process the dispenser data, the gauge data and the handheld device data obtained from the transceiver, to track the dispensing of fuel at the fuel stations.

Typically, the system further includes a display device to display results of analysis performed at the analytical engine. Additionally, the wireless communication is using one of General Packet Radio Service (GPRS) and Very-Small Aperture Terminal (VSAT). Also, the analyser further consists of checking means to check for disparity between the dispenser data, the gauge data and the handheld device data.

In accordance to a present disclosure there is provided a method for tracking dispensation of fuel from a plurality of fuel stations, the method including the steps including transmitting data relating to pricing information from a server to a controller and from the controller to handheld devices, fuel dispenser meters and price display modules at each of the fuel stations, extracting data relating to volume of fuel stored in a fuel sump, dispensing fuel from fuel dispenser nozzles, metering data from metering devices linked with each fuel dispenser in each of the fuel stations, extracting data relating to volume of fuel dispensed by the fuel dispenser nozzles, extracting data signals from handheld devices linked with each of fuel dispensers, receiving the data obtained from the fuel sump, the metering devices and the fuel dispenser nozzles and the data signals at a controller associated with the fuel station, transmitting the data and the data signals to a server corresponding to each of the fuel stations and analysing data at the server.

Typically, the step of analysing data at the server further consists the step of checking the data and the data signals for disparity.

### BRIEF DESCRIPTION OF ACCOMPANYING DRAWINGS

A system and method for tracking dispensation of fuel from a plurality of fuel stations in accordance with the present disclosure will now be described with the help of accompanying drawings, in which:

FIG. 1 illustrates a system for dispenser tracking in accordance to a prior art;

FIG. 2 illustrates a fuel dispenser tracking system in accordance to an embodiment of the present disclosure; and

FIG. 3 illustrates a comparative representation of the reduction in hardware requirements in a fuel dispensing tracking system adopting the method of data communication in accordance with the present disclosure.

### DETAILED DESCRIPTION

Conventional dispensing automation systems need independent serial communication cables to be laid from different peripheral devices/applications including dispensers, fuel sumps and price display modules to the automation system in the sales building. This needs a lot of civil work including digging of the dispenser forecourt to lay the conduits and cables securely, thus involving a lot of time, money and effort. The conventional systems are ineffective in controlling fraud and fail to identify discrepancies. They are also ineffectual for remote monitoring and analysis of periodic operations.

The method and apparatus of the present disclosure envisages a cost effective and reliable means to utilize already laid electric power cables for dispensers as means for data communication.

An exemplary embodiment of a fuel dispenser tracking system will now be described in detail with reference to the accompanying drawings. The illustrated embodiment does not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

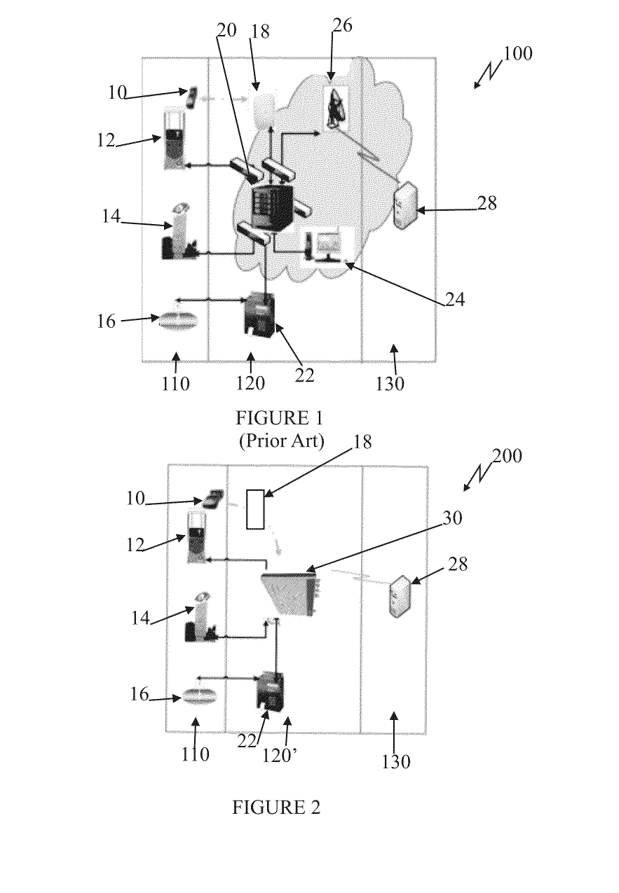

FIG. 1 illustrates a system 100 for dispenser tracking in accordance to a prior art. The physical architecture of the system 100 is primarily divided into forecourt devices 110, an IT room 120, a sales building and an enterprise level 130. The forecourt devices 110 include at least one handheld device/terminal 10, a plurality of dispensers 12, a price display module 14 and a fuel sump 16. The handheld terminals 10 serve multiple functions including displaying sale information on their user interface with regards to sale of the products, to collect payment information and controlling different parameters of the fuel dispensers. The forecourt devices 110 further including a plurality of dispensers 12 serve the primary function of dispensing products. In accordance to one embodiment, the products dispensed are fuel products including petrol and diesel and 32 dispensers are installed in one fuel station/forecourt.

The price display module 14 dynamically displays pricing information including sales prices of the products dispensed by the dispensers 12. The forecourt devices 110 further include a sump 16 to store fuel. Each of the mentioned forecourt devices 110 has cable based communication channels with corresponding master devices in the IT room 120. The hand held terminals 10 are connected to an access point 18 which in turn is connected to its master device. The dispensers 12 are connected to their master devices. The sump 16 is connected to an Automatic Tank Gauge 22 henceforth referred to as a gauge 22 which is in turn connected to its master device. All the mentioned master devices are connected to a central storing unit 20 which is in cable communication with a Very Small Aperture Terminal (VSAT) 26. The central storing unit 20 is also further connected to computing device 24 located in the sales building. The VSAT 26 wirelessly transmits the stored data from the central storage unit 20 to a server 28. The server 28 performs the function of storing, processing and retransmitting the processed data back to the central storing unit 20 via the VSAT 26. The system 100 mentioned in the prior art carries the following disadvantages:
requirement of external cabling for connecting the forecourt devices to their master devices;
longer route to transmit and receive processed data; and
lack of a central control facility for controlling and monitoring all forecourt devices.

FIG. 2 illustrates a fuel dispenser tracking system 200 in accordance to an embodiment of the present disclosure. Along with higher reliability and cost reduction the system 200 disclosed in the present disclosure:
provides a means for central processing and control of all forecourt devices 110; and
eliminates the need for additional communication cabling.

The devices in the IT room 120 and the sales building are replaced with a new automation component 120′ namely a Power Line Communication device 30 hereafter referred to as controller 30. The controller 30 is modular, compact and rugged. It reduces deployment cost by approximately 1/10^{th} of that of the automation components 120 of the conventional fuel dispensing automation system 100 as seen in FIG. 1. The main function of the controller 30 is to transmit and receive aggregated data. Another key advantage of the use of the controller 30 is the elimination of the need of extra communication cabling, wherein the controller 30 operates over existing power lines to transmit and receive data from different forecourt devices 110. The power lines facilitate in transmitting data and supplying power. The controller 30 primarily includes two components namely a first master module and a second master module. The first master module and the second master module are in data communication with each other. The first master module is connected via power lines to different devices. The other ends of the power lines are attached with slave modules. These slave modules are connected to the devices.

Each of the dispensers 12 consists of two components including a nozzle and a metering device. Actuating the nozzle allows the flow of the fuel out of the dispenser 12. The metering device associated with the fuel dispenser 12 keeps track of the fuel being dispensed and at the same time displays the current total and the selling price of the fuel. The current total and the running sum of the quantity of fuel dispensed are maintained by a totalizer installed in each fuel dispenser 12. The slave module attached to the metering device is referred to as the dispenser slave module. The dispenser slave module tracks and extracts the fuel dispensing data referred to as the dispenser meter data. The dispenser slave module also feeds the fuel dispensers 12 with the pricing data. The pricing data is the selling price of the fuel.

Each of the dispensers 12 is associated with at least one fuel sump 16. Each of the fuel sumps 16 is fitted with a gauge 22 to measure the quantity of fuel stored in the sump. Each such gauge 22 is connected with a slave module referred to as a gauge slave module. The gauge slave module tracks and extracts the data of the fuel quantity stored in the sump. Price display modules 14 are located in each of the fuel stations. Each of such price display modules 14 is attached with a slave module referred to as a price display slave module. The function of the price display slave module is to input data referred to as the pricing data into the price display module 14.

The forecourt devices 110 also include at least one handheld device 10 which communicates with at least one fuel dispenser 12 as well as with the controller 30. The handheld devices 10 offer the functionality of allowing the users to remotely control the parameters of the fuel dispensers 12. One such parameter includes pre-setting the amount of fuel to be dispensed. The handheld devices 10 also receive data about the amount of fuel dispensed by the fuel dispenser 12. The data associated with the handheld devices 10 is henceforth also referred to as data signals. The handheld devices 10 are adapted to wirelessly communicate with the fuel dispensers 12. They also wirelessly transmit data to an access point 18 which in turn communicates the data via a cabling communication means to the controller 30. The handheld devices 10 directly communicate data with the second master module. The slave modules which include the dispenser slave modules, gauge module and the pricing display slave module communicate data with the first master module.

The first master module transfers this gathered data to the second master module. The second master module in turn transmits the dispenser data, gauge data and the handheld device data to a server 28 within an enterprise level 130. The server 28 is typically located external to any fuel station. It communicates with a plurality of controllers each located in a different fuel station. The server 28 comprises of two components namely a transceiver and an analytical engine. The transceiver is a networking device to wirelessly communicate with the second master module of the controller. It receives the dispenser data, gauge data and the handheld device data from the second master module and transmits the pricing data to the second master module.

The dispenser data, gauge data and the handheld device data are extracted and processed by the analytical engine. The step of processing includes applying different checks to the collected data. Post processing, the analytical engine generates reports, identifies and flags discrepancies. In accordance to one embodiment, the system also has a provision of a display unit to graphically display the processed results. The wireless communication between the controller 30 and the server 28 takes place using one of General Packet Radio Service (GPRS) and Very-Small Aperture Terminal (VSAT). The analyzer further includes checking means to check between dispenser data, gauge data and handheld device data to identify and flag discrepancies.

The system of data transmitted/received includes:
gauge data transmitted from a gauge slave module over a power line to the first master module;
dispenser data transmitted from each of the dispenser slave modules over power lines to the first master module;
pricing data received over power lines by a plurality of dispenser meter slave modules, pricing system slave module from the first master module and by handheld devices from the second master module; and
handheld device data/data signal transmitted from the handheld devices to the second master module via the access point.

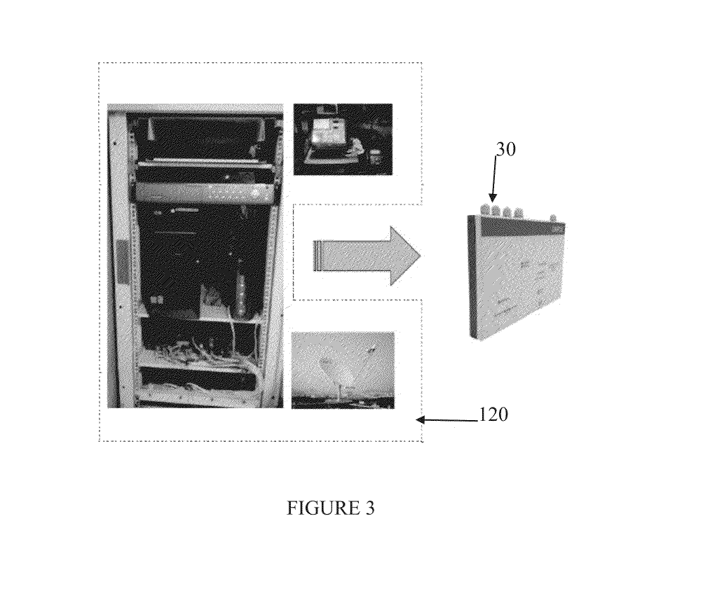

FIG. 3 illustrates a comparative representation of the reduction in hardware requirements in the fuel dispensing tracking system 200 as seen in FIG. 2 adopting the method of data communication. The apparatus of the present disclosure provides automation of processes including:
tracking the deliveries to own/independent stations;
monitoring the price at which fuel is sold;
visibility of operations at the fuel station (working hours, utilization of fuelling positions, and the like);
enhancing value to customers;
facilitating increased modes of payment;
rewarding customers for purchases (loyalty);
increasing transparency of transaction (price/automated receipts); and
encouraging cashless transactions (fleet/third party card).

### Test Results

A comparative study of technical data associated with conventional systems 120 with reference to FIG. 1 and FIG. 3 and the tracking system 30 with reference to FIG. 2 and FIG. 3 of the present disclosure is provided herein below.

| | | Power Line |
|---|---|---|
| | | Communication |
| Features | Conventional System | based System |
| Electrical | | |
| Design Standard | CE | CENELEC |
| Operating Voltage | 190 to 250 V AC | 110 V to 280 V AC |
| Operating Frequency | 50 to 60 Hz | 40 to 60 Hz |
| Output Voltage | Single | Dual Isolated |
| Conversion Efficiency | 60% | >80% |
| (AC to DC) | | |
| Protection | | |
| Under Voltage | X | ✓ |
| Over Voltage | X | ✓ |
| Output Short Circuit | X | ✓ |
| Power Consumption | 700 watt | <20 watt |
| Device | | |
| Communication | | |
| RS485/RS232 & | Requires Converters | In Built |
| Current loop | | |
| Port Isolation | 1.5 KV Opto Galvanic | 3 KV Galvanic |
| Hardware Design | PC based | Industrial Grade |
| Component Design | Cooling required | Rugged design to ensure |
| | | temperature does not |
| | | exceed 45 deg. C. |
| System Design | Nuclear | DCS Topology used in |
| | | Industrial Automation |
| Operating system | Windows/Linux | RTOS - A Power Line |
| | | Communication & DCS |
| | | operating system |
| Communication | External VSAT/GPRS | “In built” GPRS |
| Remote Diagnostic | Not Available | Available |
| Application update | Mostly “On Site” & | Remote |
| | few remote | |
| Operations & | Average to High | Negligible |
| Maintenance cost | | |
| Modularity | Entire cost on day one | Modular Expansion |
| Deployment | Special skillset & | Compact, Easy to carry |
| | Logistic(s) | & simple to install |
| | Requirements | |

The system and method described herein above with reference to fuel dispensing systems may be applied to dispensing systems for any commodity.

### Technical Advancements and Economical Significance

The technical advancements offered by the present disclosure include the realization of:
a cost effective dispenser tracking system;
a system and method for tracking dispensation of fuel from a plurality of fuel stations that can be interfaced with operating dispensing stations;
a system and method for tracking dispensation of fuel from a plurality of fuel stations that can be implemented without a need for major civil work;
a system and method for tracking dispensation of fuel from a plurality of fuel stations that is easy to install and does not involve cumbersome time consuming installation procedures;
a system and method for tracking dispensation of fuel from a plurality of fuel stations that can be easily implemented for enterprise level control;
a reliable dispenser tracking system;
a system and method for tracking dispensation of fuel from a plurality of fuel stations that can improve sales without a need for additional overheads;
a system and method for tracking dispensation of fuel from a plurality of fuel stations that does not require on-site maintenance, diagnostics or component replacement;
a system and method for tracking dispensation of fuel from a plurality of fuel stations that identifies irregularities and discrepancies at the fuel stations;
a system and method for tracking dispensing of fuel from a plurality of fuel stations that can be used for remote monitoring of the fuel stations; and
a system and method for tracking dispensation of fuel from a plurality of fuel stations which reduces hardware requirements in comparison to conventional systems.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Wherever a range of values is specified, a value up to 10% below and above the lowest and highest numerical value respectively, of the specified range, is included in the scope of the disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for tracking dispensation of fuel from a plurality of fuel stations, each fuel station having a cluster of fuel dispensers and each fuel dispenser being associated with a fuel sump, a metering device, a fuel dispensing nozzle, a price display module and at least one handheld device, wherein each handheld device is in wireless communication with the metering device of at least one dispenser, said system comprising:
a plurality of dispenser slave modules, each attached to one of said metering devices;
a plurality of gauges each mounted in one of said fuel sumps;
a plurality of gauge slave modules each attached to one of said gauges;
a plurality of price display slave modules each attached to said price display module at each of said fuel stations;
a plurality of handheld devices each located in one of said fuel stations and in wireless communication with said access point;
a plurality of controllers, wherein a controller is located in each of said fuel stations, each said controller comprising:
a first master module communicating via power lines with said dispenser slave module, said gauge slave module and said price display slave module to receive dispenser data, and gauge data from said dispenser slave module and gauge slave module and deliver pricing data to said dispenser slave module and said price display slave module; and
a second master module in data communication with said first master module and in cable communication with said access point at said fuel station to receive and send handheld device data; and
a server comprising:
a transceiver to receive from a plurality of said controllers said dispenser data, said gauge data and said handheld device data and deliver said pricing data to each of said controllers; and
an analytical engine to process said dispenser data, said gauge data and said handheld device data obtained from said transceiver, to track the dispensing of fuel at said fuel stations.

2. The system for tracking dispensation of fuel from a plurality of fuel stations as claimed in claim 1, wherein said system further includes a display device to display results of analysis performed at said analytical engine.

3. The system for tracking dispensation of fuel from a plurality of fuel stations as claimed in claim 1, wherein said wireless communication is using one of General Packet Radio Service (GPRS) and Very-Small Aperture Terminal (VSAT).

4. The system for tracking dispensation of fuel from a plurality of fuel stations as claimed in claim 1, wherein said analyser further consists of checking means to check for disparity between said dispenser data, said gauge data and said handheld device data.

5. A method for tracking dispensation of fuel from a plurality of fuel stations, said method comprising the following steps:
transmitting data relating to pricing information from a server to a controller and from said controller to handheld devices, fuel dispenser meters and price display modules at each of said fuel stations;
extracting data relating to volume of fuel stored in a fuel sump;
data from metering devices linked with each fuel dispenser in each of said fuel stations;
extracting data relating to volume of fuel dispensed by said fuel dispenser;
receiving said data obtained from said fuel sump, said metering devices and said fuel dispenser nozzles and said data signals at a controller associated with said fuel station;
transmitting said data and said data signals to a server corresponding to each of said fuel stations; and
analyzing data at said server.

6. The method for tracking dispensation of fuel from a plurality of fuel stations as claimed in claim 5, wherein the step of analysing data at said server further comprises the step of checking said data and said data signals for disparity.
